(19) United States
(12) Patent Application Publication
(10) Pub. No.: US 2025/0355116 A1
(43) Pub. Date: Nov. 20, 2025

(54) OBJECT DETECTION SENSOR AND OBJECT DETECTION METHOD

(71) Applicant: Murata Manufacturing Co., Ltd., Nagaokakyo-shi (JP)

(72) Inventors: Takatoshi KATO, Nagaokakyo-shi (JP); Hiroshi WATANABE, Nagaokakyo-shi (JP); Koichi INOUE, Nagaokakyo-shi (JP)

(21) Appl. No.: 19/291,952

(22) Filed: Aug. 6, 2025

Related U.S. Application Data
(63) Continuation of application No. PCT/JP2023/041264, filed on Nov. 16, 2023.

(30) Foreign Application Priority Data
Feb. 10, 2023 (JP) 2023-019370

(51) Int. Cl. G01S 17/42

(52) U.S. Cl. CPC G01S 17/42

(57) ABSTRACT

An optical detection sensor includes at least four first optical elements and at least one second optical element arranged on a virtual plane. One of the first and second optical elements is a light emitter, and another of the first and second optical elements is a light receiver. At least four first optical elements and one second optical element define a minimum unit. The directional characteristics of the four first optical elements of the minimum unit are the same. The at least four first optical elements are neither arranged on one common straight line passing through the second optical element, nor on one common circumference centered on the second optical element. A calculator obtains a distance from the virtual plane to a target object on a reference axis, an inclination angle, and an inclination azimuth angle of a surface of the target object based on a measurement value.

### CROSS REFERENCE TO RELATED APPLICATIONS

This application claims the benefit of priority to Japanese Patent Application No. 2023-019370 filed on Feb. 10, 2023 and is a Continuation Application of PCT Application No. PCT/JP2023/041264 filed on Nov. 16, 2023. The entire contents of each application are hereby incorporated herein by reference.

### BACKGROUND OF THE IVNENTION

### 1. Field of the Invention

The present invention relates to object detection sensors and object detection methods.

### 2. Description of the Related Art

There is known a sensor which detects the distance to a target object and the attitude of the target object by using a light receiver to detect, among the light emitted from a light emitter, the light reflected by the target object (see, for example, Japanese Examined Patent Application Publication No. 62-17163). The sensor described in Japanese Examined Patent Application Publication No. 62-17163 includes two light emitters with strong scattering property and one light receiver with strong directivity. The one light receiver and the two light emitters are arranged on a straight line. Among the light radiated from the light emitters, the light diffusely reflected by the surface of the target object is received by the light receiver. The distance from the light receiver to the target object is derived by using the fact that the distance between the light emitters and the target object is different for each of the two light emitters, and the fact that the illumination intensities at the different positions of the target object are different.

Further, by providing a total of four light emitters in which two light emitters are respectively arranged at positions of equal distance on both sides of the light receiver, the inclination of the surface of the target object in the direction in which the light emitters are arranged can also be obtained.

In the sensor described in Japanese Examined Patent Application Publication No. 62-17163, although it is possible to obtain the inclination of the target object in the direction in which the light emitters are arranged, it is not possible to obtain the inclination of the target object in other directions.

### SUMMARY OF THE INVENTION

Example embodiments of the present invention provide object detection sensors and object detection methods each able to obtain a distance to a target object and an azimuth at which the surface of the target object is inclined.

An object detection sensor according to an example embodiment of the present invention includes at least four first optical elements arranged on a virtual plane, at least one second optical element arranged on the virtual plane, and a calculator, in which one of the at least four first optical elements and the at least one second optical element is a light emitter, and another of the at least four first optical elements and the at least one second optical element is a light receiver, at least four of the first optical elements and one of the at least one second optical element define a minimum unit, directional characteristics of the at least four first optical elements of the minimum unit are the same, and directional characteristics of the at least one second optical element are such that, when a straight line extending from the at least one second optical element in a direction normal to the virtual plane is defined as a reference axis, a tilt angle at which an illumination intensity or a light receiving sensitivity in a direction tilting from the reference axis becomes about ½ of the illumination intensity or the light receiving sensitivity in a direction of the reference axis is about 15° or less, the at least four first optical elements of the minimum unit are neither arranged on one common straight line passing through the at least one second optical element, nor on one common circumference centered on the at least one second optical element, and the calculator is configured or programmed to obtain a distance from the virtual plane to a target object on the reference axis, an inclination angle of a direction normal to a surface of the target object with respect to the reference axis, and an inclination azimuth angle based on a measurement value, which is a light receiving intensity when each of the at least four first optical elements of the minimum unit and the at least one second optical element are operated.

An object detection method according to another example embodiment of the present invention is a method of operating, of a minimum unit including each of at least four first optical elements and at least one second optical element arranged on a common virtual plane, the at least four first optical elements and the at least one second optical element, and detecting a target object on a reference axis extending from the at least one second optical element in a direction normal to the virtual plane, wherein one of the at least four first optical elements and the at least one second optical element is a light emitter, and another of the at least four first optical elements and the at least one second optical element is a light receiver, directional characteristics of the at least four first optical elements of the minimum unit are the same, and directional characteristics of the at least one second optical element are such that a tilt angle at which an illumination intensity or a light receiving sensitivity in a direction tilting from the reference axis becomes about ½ of the illumination intensity or the light receiving sensitivity in a direction of the reference axis is about 15° or less, and the at least four first optical elements of the minimum unit are neither arranged on one common straight line passing through the at least one second optical element, nor on one common circumference centered on the at least one second optical element, the object detection method includes obtaining a measurement value of luminance when the target object is used as a new light source based on light emitted from either the at least four first optical elements or the at least one second optical element of the minimum unit, reflected by the target object, and received by another of the at least four first optical elements and the at least one second optical element of the minimum unit, and calculating, based on the measurement value, at least one of a reflectivity of a surface of the target object, a distance from the virtual plane to the target object on the reference axis, an inclination angle of the surface of the target object with respect to the reference axis, or an inclination azimuth angle of the surface of the target object.

Since the four first optical elements of the minimum unit are neither arranged on one common straight line passing through the second optical element, nor on one common circumference centered on the second optical element, a distance to the target object and an azimuth at which the surface of the target object is inclined can be obtained.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a schematic perspective view of an object detection sensor according to a first example embodiment of the present invention, and FIG. 1B is a view showing an example of the positional relationship of four first optical elements and one second optical element in plan view.

FIG. 2 is a view showing the positional relationship and a coordinate system of one of the first optical elements, the second optical element, and a target object.

FIG. 3 is a schematic view showing the directional characteristics of the first optical elements and the second optical element.

FIG. 4 is a flowchart showing a procedure to be executed by a calculator of the object detection sensor according to the first example embodiment of the present invention.

FIG. 5 is a view showing the planar positional relationship of four first optical elements and one second optical element of an object detection sensor according to a modification of the first example embodiment of the present invention.

FIG. 6 is a schematic perspective view of an object detection sensor according to another modification of the first example embodiment of the present invention.

FIG. 7 is a view showing the planar positional relationship of first optical elements and a second optical element of an object detection sensor according to a second example embodiment of the present invention.

FIGS. 8A and 8B are views respectively showing the planar positional relationship of first optical elements and second optical elements of an object detection sensor according to a third example embodiment of the present invention, and the planar positional relationship of first optical elements and second optical elements of an object detection sensor according to a modification of the third example embodiment of the present invention.

FIG. 9 is a view showing the planar positional relationship of first optical elements and second optical elements of an object detection sensor according to a fourth example embodiment of the present invention.

FIG. 10 is a schematic plan view showing the positional relationship of a plurality of first optical elements included in one minimum unit, of a plurality of minimum units, and one second optical element of an object detection sensor according to a fifth example embodiment of the present invention.

FIG. 11 is a graph showing the relationship between a ratio R (Equation (8)) when two first optical element pairs are operated and a distance z.

FIG. 12 is a flowchart showing a procedure to be executed by a calculator of the object detection sensor according to the fifth example embodiment of the present invention.

### DETAILED DESCRIPTION OF THE EXAMPLE EMBODIMENTS

Example embodiments of the present invention will be described in detail below with reference to the drawings.

### First Example Embodiment

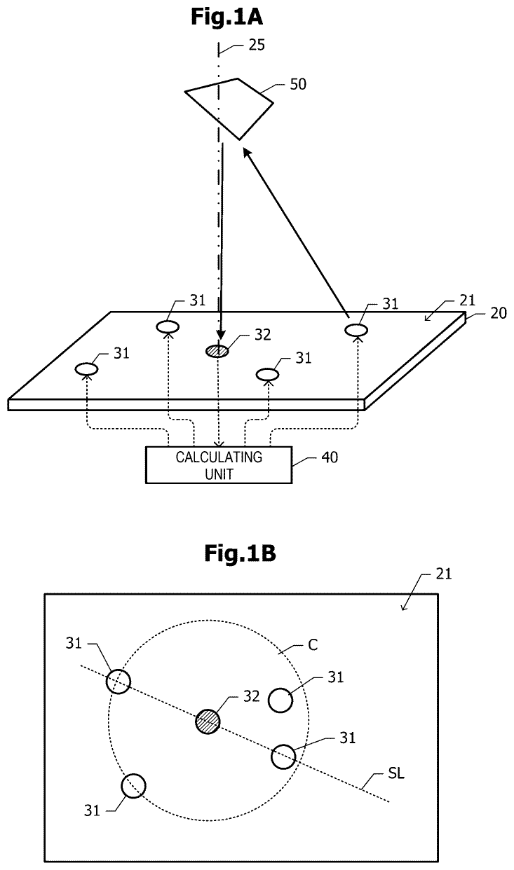

An object detection sensor and an object detection method according to a first example embodiment of the present invention will be described with reference to FIGS. 1 to 4.

FIG. 1A is a schematic perspective view of the object detection sensor according to the first example embodiment. The object detection sensor according to the first example embodiment includes four first optical elements 31, one second optical element 32, and one calculator 40. Each of the four first optical elements 31 is a light emitter and emits light under control of the calculator 40. Examples of the first optical element 31 include a light emitting diode (LED) or a vertical cavity surface emitting laser (VCSEL). The second optical element 32 is a light receiver and outputs an electric signal corresponding to the intensity of the received light. Such an electric signal is taken into the calculator 40. Examples of the second optical element 32 include a photodiode, a phototransistor, of a CdS cell. In FIG. 1A, the light receiver is hatched.

The four first optical elements 31 and the one second optical element 32 are arranged on a common virtual plane 21. For example, the four first optical elements 31 and the one second optical element 32 are mounted on a flat surface of a substrate 20. At this time, the mounting surface of the substrate 20 coincides or substantially coincides with the virtual plane 21. The object detection sensor according to the first example embodiment detects a target object 50 that passes through the second optical element 32 and that is located on a virtual straight line (hereinafter referred to as a “reference axis 25”) extending in the direction normal to the virtual plane 21. Specifically, the distance from the virtual plane 21 to the target object 50 and the attitude of the target object 50 are detected based on the intensity of the light emitted from each of the first optical elements 31, reflected by the target object 50, and incident on the second optical element 32. Here, the expression “passes through the second optical element 32” means passing through the geometric center of a light receiving region of the second optical element 32.

FIG. 1B is a view showing an example of the positional relationship of the four first optical elements 31 and the one second optical element 32 in plan view. The four first optical elements 31 are neither arranged on one common straight line passing through the second optical element 32, nor on one common circumference centered on the second optical element 32. In other words, when a straight line SL passing through the second optical element 32 and one of the first optical elements 31 is drawn, at least one of the other three first optical elements 31 is arranged at a position deviating from the straight line SL. In the example shown in FIG. 1B, two of the first optical elements 31 are arranged at positions deviating from the straight line SL. Further, when a circumference C passing through one of the first optical elements 31 with the second optical element 32 as the center is drawn, at least one of the other three first optical elements 31 is arranged at a position deviating from the circumference C. In the example shown in FIG. 1B, two of the first optical elements 31 are arranged at positions deviating from the circumference C.

Here, whether or not the first optical element 31 is located on the straight line SL or on the circumference C is determined with the geometric center of a light emitting region of the first optical element 31 as a reference. Also, whether or not the second optical element 32 is located on the straight line SL is determined with the geometric center of a light receiving region of the second optical element 32 as a reference. The circumference centered on the second optical element 32 means a circumference centered on the geometric center of the light receiving region of the second optical element 32. With such a configuration, the distance between at least one of the first optical elements 31 and the second optical element 32 is different from the distance between the other three first optical elements 31 and the second optical element 32. Each of the four first optical elements 31 and one second optical element 32 define a total of four light-receiving and light-emitting pairs.

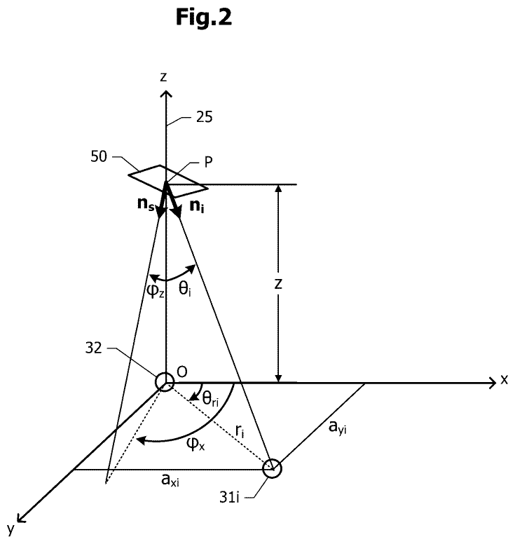

Next, the definition of a coordinate system and various parameters used in this description will be explained with reference to FIG. 2. FIG. 2 is a view showing the positional relationship and a coordinate system of one first optical element 31i, among the four first optical elements 31, the second optical element 32, and the target object 50. The xy plane of an xyz rectangular coordinate system corresponds to the virtual plane 21 (FIG. 1A), and the second optical element 32 is located at the origin O. The z-axis corresponds to the reference axis 25. A left-hand system is used as the xyz rectangular coordinate system.

When the four first optical elements 31 are numbered sequentially from 1, the i-th first optical element 31 is denoted by 31i. The x and y coordinates of the first optical element 311 are denoted by aₓᵢ and a_{yi}, respectively. The distance from the origin O to the first optical element 31i is denoted by rᵢ. The azimuth angle of the position of the first optical element 31 with the x-axis as the reference direction is denoted by θᵣᵢ.

The intersection point between the surface of the target object 50 facing the origin O and the reference axis 25 (hereinafter referred to as a representative point of the target object 50) is denoted by P. The distance from the origin 0 (the second optical element 32) to the representative point P of the target object 50 is denoted by z. In this description, the distance z from the second optical element 32 to the representative point P of the target object 50 may be simply referred to as the distance z from the second optical element 32 to the target object 50. The unit vector from the representative point P of the target object 50 to the first optical element 31i is denoted by nᵢ. The angle between the unit vector nᵢ and the reference axis 25 is denoted by θᵢ.

The unit normal vector of the surface of the target object 50 at the position of the representative point P is denoted by nₛ. The angle between the unit normal vector ns and the reference axis 25 is denoted by ϕ_{z}. The angle ϕ_{z} is referred to as an inclination angle of the target object 50. The angle between the x-axis and the vertical projection image of the unit normal vector nₛ onto the xy-plane is denoted by ϕₓ. The angle ϕₓ is referred to as an inclination azimuth angle of the surface of the target object 50.

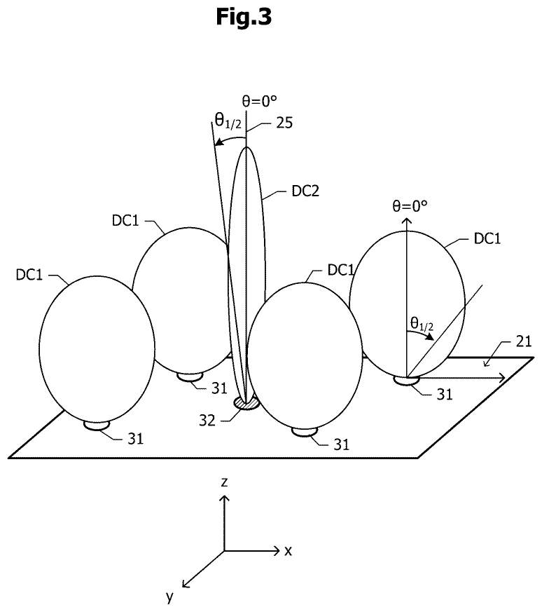

FIG. 3 is a schematic view showing the directional characteristics of the first optical elements 31 and the second optical element 32. In FIG. 3, directional characteristics DC1 of each of the first optical elements 31 and directional characteristics DC2 of the second optical element 32 are shown in a graph. The tilt angle from the positive direction of the z-axis is denoted by θ. In the first optical element 31, the light intensity becomes maximum at θ=0° (front direction), and the light intensity decreases as the tilt angle e increases. The tilt angle θ at which the light intensity becomes about ½ of the light intensity in the front direction is referred to as a half-value half-angle θ_{1/2}. In the second optical element 32, the light receiving sensitivity becomes maximum at θ=0° (front direction), and the light receiving sensitivity decreases as the tilt angle θ increases. The tilt angle θ at which the light receiving sensitivity becomes about ½ of the light receiving sensitivity in the front direction is referred to as the half-value half-angle θ_{1/2}.

The first optical element 31 has wider-angle directional characteristics than the directional characteristics of the second optical element 32. For example, the first optical element 31 has wide-angle directional characteristics such that the target object 50 (FIG. 1A) located on the reference axis 25 is irradiated with a light of sufficient intensity. The second optical element 32 has sharp directional characteristics such that the sensitivity becomes sufficiently low for the reflected light from an object at a position greatly deviating from the reference axis 25. For example, the half-value half-angle θ_{1/2} of the directional characteristics of the second optical element 32 is preferably about 15° or less, more preferably about 10° or less, and even more preferably about 5° or less.

When the directional characteristics of the first optical element 31 do not depend on the azimuth angle, the directional characteristics LD(θ) of the first optical element 31 can generally be approximated by the following equation.

LD(θ)=cosⁿθ. . . (1)

Here, n is a parameter determined by the directional characteristics of the first optical element 31. The larger the parameter n, the sharper the directional characteristics.

The light emitting intensity of the i-th first optical element 31i in the front direction is denoted by Gᵢ, and the light receiving sensitivity of the second optical element 32 is denoted by C. The reflectivity of the surface of the target object 50 is denoted by α. The light intensity LIi at the representative point P is expressed by the following equation. Note that the directional characteristics LD(θ) of the four first optical elements 31 are the same or substantially the same.

$$LIi = {cos}^{n} {θ}_{i} = {( \frac{z}{\sqrt{{r}_{i}^{2} + {z}^{2}}} )}^{n} \qquad ( 2 )$$

The intensity of the light detected by the second optical element 32, that is, the luminance Li of the representative point P, when the representative point P is viewed from the second optical element 32 as a new light source, is expressed by the following equation.

$$Li = \frac{C α {G}_{i}}{{z}^{β}} {( \frac{z}{\sqrt{{r}_{i}^{2} + {z}^{2}}} )}^{n} \cdot \frac{[ \frac{{r}_{i} sin {φ}_{z}}{cos {φ}_{z}} cos ( {θ}_{ri} - {φ}_{x} ) + z ]}{{( {r}_{i}^{2} + {z}^{2} )}^{\frac{3}{2}}} \qquad ( 3 )$$

As the distance z increases, since the field of view of the second optical element 32 becomes wide, the term Z_{β} of the denominator on the right side of Equation (3) reduces the contribution to the luminance per unit area of the surface of the target object 50 (FIG. 1A). When the light is irradiated on a wide area of the surface of the target object 50 and the surface of the target object 50 is larger than the field of view of the second optical element 32, the entire field of view of the second optical element 32 receives light even if the distance z increases. In such a case, the influence of the term z_{β} becomes small. In reality, β in Equation (3) takes any value in a range from 0 to 2 depending on the shape and size of the target object 50 and the value of half-value half-angle β_{1/2} of the directional characteristics of the second optical element 32.

Since the parameter CαGᵢ/z_{β} on the right side of Equation (3) is common for each of the four first optical elements 31, the unknown numbers in Equation (3) are parameter CαGᵢ/zβ, distance z, inclination azimuth angle ϕₓ, and inclination angle ϕ_{z}, and four Equations (3) are generated where i=1, 2, 3, and 4, respectively. Since the four first optical elements 31 are neither arranged on one common straight line passing through the second optical element 32, nor on one common circumference centered on the second optical element 32, the four equations are linearly independent. Therefore, the calculator 40 can calculate the parameter CαGᵢ/z_{β}, the distance z, the inclination azimuth angle ϕₓ, and the inclination angle ϕ_{z} by solving the simultaneous equations with 4 variables.

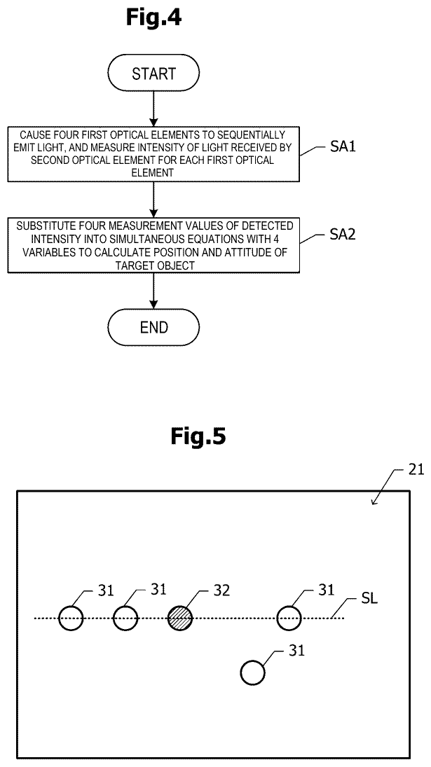

Next, an example of a method of detecting an object by the object detection sensor according to the first example embodiment will be described with reference to FIG. 4. FIG. 4 is a flowchart showing a procedure to be executed by the calculator 40 (FIG. 1A) of the object detection sensor according to the first example embodiment.

The calculator 40 (FIG. 1A) causes the four first optical elements 31 to sequentially emit light, and measures the intensity of the light received by the second optical element 32 for each of the first optical elements 31 (step SA1). Further, the calculator 40 substitutes each of the four measurement values measured by the second optical element 32 into Equation (3) to generate simultaneous equations with 4 variables, and solves the simultaneous equations with 4 variables to obtain the distance z, the inclination azimuth angle ϕₓ, and the inclination angle ϕ_{z} (step SA2).

Next, excellent effects of the first example embodiment will be described.

In the first example embodiment, the distance z, the inclination azimuth angle ϕₓ, and the inclination angle ϕ_{z} can be obtained by the four first optical elements 31 and the one second optical element 32. In other words, instead of only obtaining the inclination angle related to a specific direction, it is possible to obtain the azimuth angle at which the surface of the target object 50 is inclined.

Next, an object detection sensor according to a modification of the first example embodiment will be described.

In the object detection sensor according to the first example embodiment, the directional characteristics LD(θ) of the four first optical elements 31 are isotropic instead of depending on the azimuth angle, but they do not necessarily have to be isotropic. For example, if the directional characteristics can be converted, by performing coordinate conversion, into a form that does not depend on the azimuth angle, the directional characteristics do not necessarily have to be isotropic.

For example, when the half-value half-angle θ_{1/2} in the xz plane shown in FIG. 3 is about twice the half-value half-angle θ_{1/2} in the yz plane, if the value of the y-axis is doubled, the half-value half-angle θ_{1/2} in the xz plane becomes equal or substantially equal to the half-value half-angle θ_{1/2} in the yz plane, which is equivalent to the case where the directional characteristics do not depend on the azimuth angle. Therefore, by performing coordinate conversion, simultaneous equations having the same form as Equation (3) can be obtained.

Next, an object detection sensor according to another modification of the first example embodiment will be described with reference to FIG. 5. FIG. 5 is a view showing the planar positional relationship of the four first optical elements 31 and one second optical element 32 of the object detection sensor according to the present modification.

In the object detection sensor according to the first example embodiment, none of three of the four first optical elements 31 (FIG. 1B) are arranged on one straight line. In contrast, in the modification shown in FIG. 5, three first optical elements 31 and one second optical element 32 are arranged on one straight line SL, and the remaining one first optical element 31 is arranged at a position deviating from the straight line SL. Even in such a case, if the simultaneous equations with 4 variables of the four equations (3) defined for each of the four first optical elements 31 are linearly independent, the distance z, the inclination azimuth angle ϕₓ, and the inclination angle ϕ_{z} can be obtained as in the first example embodiment.

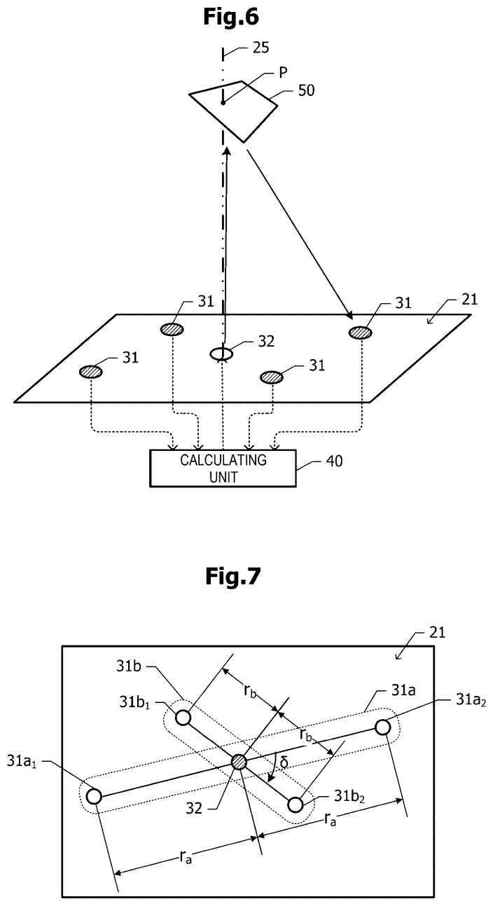

Next, an object detection sensor according to another modification of the first example embodiment will be described with reference to FIG. 6. FIG. 6 is a schematic perspective view of the object detection sensor according to the present modification.

In the first example embodiment (FIG. 1A), the four first optical elements 31 are light emitters and the one second optical element 32 is a light receiver. In contrast, in the present modification, one second optical element 32 is a light emitter and four first optical elements 31 are light receivers. In FIG. 6, the light receivers are hatched. The directional characteristics of the first optical element 31 and the second optical element 32 are the same or substantially the same as those of the first optical element 31 and the second optical element 32 of the object detection sensor according to the first example embodiment.

In other words, the second optical element 32 mainly irradiates light to the target object 50 located on the reference axis 25, and substantially does not irradiate light in directions greatly deviating from the reference axis 25. For example, the half-value half-angle θ_{1/2} of the directional characteristics of the light emitted from the second optical element 32 is preferably about 15° or less, more preferably about 10° or less, and even more preferably about 5° or less.

Further, the four first optical elements 31 have wider-angle directional characteristics of light receiving sensitivity than the directional characteristics of the second optical element 32. For example, the first optical elements 31 have sufficient light receiving sensitivity for the light reflected by the target object 50 (FIG. 1A) located on the reference axis 25.

When detecting an object, the second optical element 32 is caused to emit light, and the light reflected from the target object 50 is received by each of the four first optical elements 31. In the present modification, the luminance of the representative point P on the surface of the target object 50 is also expressed by Equation (3). Therefore, in the present modification, the distance z, the inclination azimuth angle ϕₓ, and the inclination angle ϕ_{z} can be obtained as in the first example embodiment.

### Second Example Embodiment

Next, an object detection sensor according to a second example embodiment of the present invention will be described with reference to FIG. 7. Hereinafter, the configurations common to the object detection sensor according to the first example embodiment described with reference to FIGS. 1A to 4 will be omitted.

FIG. 7 is a view showing the planar positional relationship of four first optical elements 31 and one second optical element 32 of the object detection sensor according to the second example embodiment. In the second example embodiment, as in the first example embodiment, the four first optical elements 31 and the one second optical element 32 are arranged on a virtual plane 21.

In the first example embodiment (FIG. 1B), none of the three first optical elements 31 of the four first optical elements 31 are arranged on one straight line, and the four first optical elements 31 are not arranged on one common circumference centered on the second optical element 32. In the second example embodiment, in addition the above conditions, the four first optical elements 31 are arranged so that the following conditions are satisfied.

In the second example embodiment, among the four first optical elements 31, two first optical elements 31a₁ and 31a₂ are arranged in mutually point-symmetric positions with respect to the second optical element 32, and the other two first optical elements 31b₁ and 31b₂ are also arranged in mutually point-symmetric positions with respect to the second optical element. The distance from the second optical element 32 to each of the first optical elements 31a₁ and 31a₂ is denoted by rₐ, and the distance from the second optical element 32 to each of the first optical elements 31b₁ and 31b₂ is denoted by r_{b}. The angle between a straight line passing through the two first optical elements 31a₁ and 31a₂ and a straight line passing through the other two first optical elements 31b₁ and 31b₂ is denoted by δ. The angle δ is greater than about 0° and less than about 180°.

The two first optical elements 31 in mutually point-symmetric relationship with each other are referred to as a first optical element pair. In the second example embodiment, the two first optical elements 31a₁ and 31a₂ define one first optical element pair 31a, and the other two first optical elements 31b₁ and 31b₂ define another first optical element pair 31b.

When Equation (3) is applied to the first optical element 31a₁, the following equation can be obtained.

$${L}_{a 1} = \frac{C α {G}_{a 1}}{{z}^{β}} {( \frac{z}{\sqrt{{r}_{a}^{2} + {z}^{2}}} )}^{n} \cdot \frac{[ \frac{{r}_{a} sin {φ}_{z}}{cos {φ}_{z}} cos ( {θ}_{ra 1} - {φ}_{x} ) + z ]}{{( {r}_{a}^{2} + {z}^{2} )}^{\frac{3}{2}}} \qquad ( 4 )$$

When Equation (3) is applied to the first optical element 31a₂, the following equation can be obtained.

$${L}_{a 2} = \frac{C α {G}_{a 2}}{{z}^{β}} {( \frac{z}{\sqrt{{r}_{a}^{2} + {z}^{2}}} )}^{n} \cdot \frac{[ \frac{{r}_{a} sin {φ}_{z}}{cos {φ}_{z}} cos ( {θ}_{ra 2} - {φ}_{x} ) + z ]}{{( {r}_{a}^{2} + {z}^{2} )}^{\frac{3}{2}}} \qquad ( 5 )$$

In Equations (4) and (5), since Gₐ₁=Gₐ₂ and since θᵣₐ₁+θᵣₐ₂=180°, the following equation can be obtained from Equations (4) and (5).

$${L}_{a 1} + {L}_{a 2} = 2 \frac{C α {G}_{a 1}}{{z}^{β}} {( \frac{z}{\sqrt{{r}_{a}^{2} + {z}^{2}}} )}^{n} \cdot \frac{1}{{( {r}_{a}^{2} + {z}^{2} )}^{\frac{3}{2}}} \qquad ( 6 )$$

Similarly, the following equation can be obtained for the first optical elements 31b₁ and 31b₂.

$${L}_{b 1} + {L}_{b 2} = 2 \frac{C α {G}_{a 1}}{{z}^{β}} {( \frac{z}{\sqrt{{r}_{a}^{2} + {z}^{2}}} )}^{n} \cdot \frac{1}{{( {r}_{b}^{2} + {z}^{2} )}^{\frac{3}{2}}} \qquad ( 7 )$$

The first optical elements 31a₁ and 31a₂ of the first optical element pair 31a including the first optical elements 31a₁ and 31a₂ are respectively caused to emit light, and measurement values obtained when the second optical element 32 receives light are summed, and the first optical elements 31b₁ and 31b₂ of the first optical element pair 31b including the first optical elements 31b₁ and 31b₂ are respectively caused to emit light, and measurement values obtained when the second optical element 32 receives light are summed. The ratio R of the sum of the measurement values obtained when the second optical element 32 receives light emitted by the first optical elements 31a₁ and 31a₂ to the sum of the measurement values obtained when the second optical element 32 receives light emitted by the first optical elements 31b₁ and 31b₂ is expressed by the following equations from equations (6) and (7).

$$R = \frac{{L}_{b 1} + {L}_{b 2}}{{L}_{a 1} + {L}_{a 2}} = \frac{{( {r}_{a}^{2} + {z}^{2} )}^{\frac{n + 3}{2}}}{{( {r}_{b}^{2} + {z}^{2} )}^{\frac{n + 3}{2}}} \qquad ( 8 )$$

Since the unknown number in Equation (8) is only z, the distance z to the target object 50 can be calculated from the ratio R.

Further, the following equation can be obtained from equations (4) and (5) for the first optical element pair 31a.

$$\begin{matrix}{L}_{a 1} - {L}_{a 2} = 2 \frac{C α {G}_{a 1}}{{z}^{β}} {( \frac{z}{\sqrt{{r}_{a}^{2} + {z}^{2}}} )}^{n} \cdot \frac{[ \frac{{r}_{a} sin {φ}_{z}}{cos {φ}_{z}} cos ( {θ}_{r a 1} - {φ}_{x} ) ]}{{( {r}_{a}^{2} + {z}^{2} )}^{\frac{3}{2}}} \\ = ( {L}_{a 1} + {L}_{a 2} ) \frac{{r}_{a}}{z} tan {φ}_{z} cos ( {θ}_{ra 1} - {φ}_{x} )\end{matrix} \qquad ( 9 )$$

Similarly, the following equation can be obtained for the first optical element pair 31b.

$$\begin{matrix}{L}_{b 1} - {L}_{b 2} = 2 \frac{C α {G}_{a 1}}{{z}^{β}} {( \frac{z}{\sqrt{{r}_{b}^{2} + {z}^{2}}} )}^{n} \cdot \frac{[ \frac{{r}_{b} sin {φ}_{z}}{cos {φ}_{z}} cos ( {θ}_{rb 1} - {φ}_{x} ) ]}{{( {r}_{b}^{2} + {z}^{2} )}^{\frac{3}{2}}} \\ = ( {L}_{b 1} + {L}_{b 2} ) \frac{{r}_{b}}{z} tan {φ}_{z} cos ( {θ}_{rb 1} - {φ}_{x} )\end{matrix} \qquad ( 10 )$$

The following equation is derived from Equations (9) and (10).

$${L}_{b 1} - {l}_{b 2} = \frac{1}{R} ( {L}_{a 1} - {L}_{a 2} ) cos δ - \frac{1}{R} \sqrt{{A}_{1}^{2} - {( {L}_{a 1} - {L}_{a 2} )}^{2}} sin δ \qquad ( 11 )$$

Here, parameter R is defined by Equation (8), and parameter A₁ is defined by the following equation.

$${A}_{1} = ( {L}_{a 1} + {L}_{a 2} ) \frac{{r}_{a}}{z} tan {φ}_{z} \qquad ( 12 )$$

The value of parameter A₁ can be calculated from Equation (11). When the value of parameter A₁ is known, the inclination angle ϕ_{z} can be calculated from Equation (12). Further, the inclination azimuth angle ϕₓ can be calculated from Equation (9). In such a manner, the inclination angle ϕ_{z} and the inclination azimuth angle ϕₓ can be calculated by obtaining the sum and difference of the measurement values of the two first optical element pairs 31a and 31b and performing a simple algebraic calculation.

Next, excellent effects of the second example embodiment will be described.

In the second example embodiment, the distance z to the target object 50, the inclination angle ϕ_{z}, and the inclination azimuth angle ϕₓ of the surface of the target object 50 can be obtained by performing a simple algebraic calculation without solving the simultaneous equations with 4 variables.

Next, an object detection sensor according to a modification of the second example embodiment will be described.

In the second example embodiment, the four first optical elements 31 are light emitters and the one second optical element 32 is a light receiver. Conversely, the one second optical element 32 may alternatively be a light emitter and the four first optical elements 31 may alternatively be light receivers.

### Third Example Embodiment

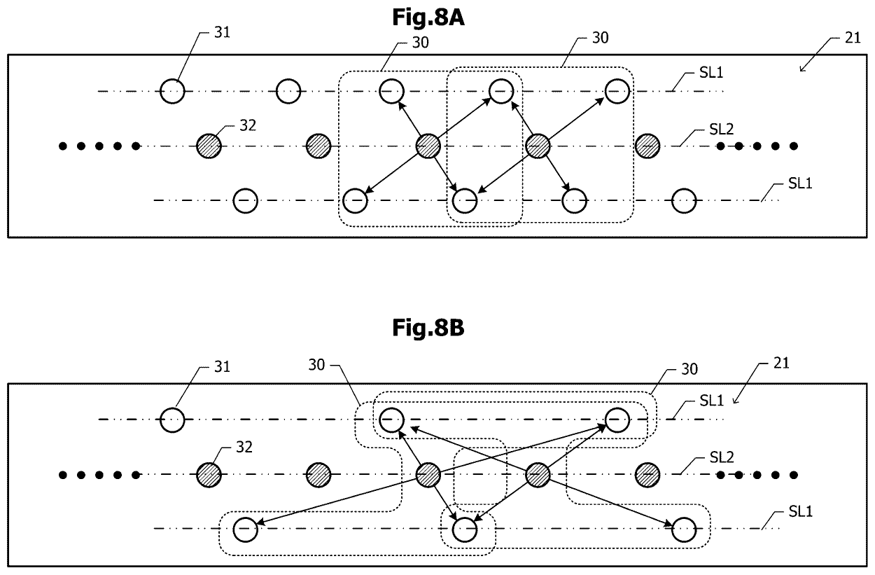

Next, an object detection sensor according to a third example embodiment of the present invention will be described with reference to FIG. 8A. Hereinafter, configurations common to the object detection sensor according to the second example embodiment described with reference to FIG. 7 will be omitted.

FIG. 8A is a view showing the planar positional relationship of first optical elements 31 and second optical elements 32 of the object detection sensor according to the third example embodiment. The object detection sensor according to the second example embodiment (FIG. 7) includes one second optical element 32 and four first optical elements 31. In contrast, the object detection sensor according to the third example embodiment includes a plurality of first optical elements 31 and a plurality of second optical elements 32 both arranged on a virtual plane 21. In FIG. 8A, the light receivers are hatched.

The plurality of second optical elements 32 are arranged at equal or substantially equal intervals along one straight line SL2. The plurality of first optical elements 31 are arranged at equal or substantially equal intervals along each of two straight lines SL1 extending parallel or substantially parallel to the straight line SL2 with the straight line SL2 interposed therebetween. The interval between the plurality of first optical elements 31 arranged on the straight line SL1 is equal or substantially equal to the interval between the plurality of second optical elements 32 arranged along the straight line SL2. The interval between one of the two straight line SL1 and the straight line SL2 is equal or substantially equal to the interval between the other one of the straight lines SL1 and the straight line SL2. A first optical element 31 is arranged at the intersection of a straight line passing through one of the second optical elements 32 and one of the first optical elements 31 on one of the straight lines SL1 and the other of the straight lines SL1.

With such a configuration, it is possible to select two or more sets of two first optical elements 31, each set including two first optical elements 31 arranged in mutually point-symmetric positions with respect to each of the plurality of second optical elements 32. Among the two first optical elements 31 arranged in mutually point-symmetric positions, one first optical element 31 is arranged on one straight line SL1, and the other first optical element 31 is arranged on the other straight line SL1. One second optical element 32 and two first optical element pairs, each first optical element pair including two first optical elements 31 arranged in mutually point-symmetric positions with respect to the second optical element 32, are collectively referred to as a “minimum unit 30”.

The distance z to the target object 50, the inclination angle ϕ_{z} and the inclination azimuth angle ϕₓ of the surface of the target object 50 can be obtained by each of the plurality of minimum units 30, as in the second example embodiment (FIG. 7).

Next, excellent effects of the third example embodiment will be described.

In the third example embodiment, the distance z from each of the plurality of second optical elements 32 arranged along the along the straight line SL2 to target object 50 in the direction orthogonal or substantially orthogonal to the virtual plane 21, as well as the inclination angle ϕ_{z} and the inclination azimuth angle ϕₓ of the surface of the target object 50 can be obtained. Therefore, the line profile of the surface of the target object 50 with respect to a direction parallel or substantially parallel to the straight line SL2 can be obtained. Further, the inclination angle of the surface of the target object 50 with respect to a direction orthogonal or substantially orthogonal to the straight line SL2 on the virtual plane 21 can be obtained from the inclination angle ϕ_{z} and the inclination azimuth angle ϕₓ obtained for each of the plurality of minimum units 30.

In the third example embodiment, one first optical element 31 is shared by a plurality of minimum units 30. Therefore, the number of the first optical elements 31 can be reduced compared with the case where a first optical element 31 is not shared by a plurality of minimum units. Further, in the third example embodiment, no first optical element 31 is arranged between the plurality of second optical elements 32 arranged along the straight line SL2. Therefore, the second optical elements 32 can be densely arranged along the straight line SL2.

Four first optical elements 31 can be selected with respect to one second optical element 32 so that the relative positional relationship of the one second optical element 32 and the four first optical elements 31, which define one minimum unit 30, is the same or substantially the same for all minimum units 30. If the relative positional relationship of one second optical element 32 and four first optical elements 31 is the same or substantially the same for all the minimum units 30, the values of the variables rₐ, r_{b}, θᵣₐ₁, and θ_{rb1} are the same or substantially the same in the calculation of equations (8), (11) and (12) between the minimum units 30. Therefore, an excellent effect of facilitating calculation is obtained.

Next, an object detection sensor according to a modification of the third example embodiment will be described with reference to FIG. 8B. FIG. 8B is a view showing the planar positional relationship of first optical elements 31 and second optical elements 32 of the object detection sensor according to the modification of the third example embodiment.

In the third example embodiment (FIG. 8A), the interval between the plurality of second optical elements 32 arranged along the straight line SL2 and the interval between the plurality of first optical elements 31 arranged along the straight line SL1 are the same or substantially the same. In contrast, in the modification shown in FIG. 8B, the interval between the plurality of first optical elements 31 arranged along the straight line SL1 is wider than the interval between the plurality of second optical elements 32 arranged along the straight line SL2. In other words, the number of the first optical elements 31 is smaller than the number of the first optical elements 31 of the object detection sensor according to the third example embodiment.

Thus, even if the interval between the first optical elements 31 is wider than the interval between the second optical elements 32, the four first optical elements 31 defining the minimum unit 30 can be selected for each of the plurality of second optical elements 32. In the modification shown in FIG. 8B, the number of the first optical elements 31 can be further reduced than in the case of the third example embodiment shown in FIG. 8A. It should be noted that, in the present modification, the values of the variables r_{d}, r_{b}, θ_{rd1}, and θ_{rb1} of the equations (8), (11), and (12) are not the same between the minimum units 30.

Next, another modification of the third example embodiment will be described. In the third example embodiment, the plurality of first optical elements 31 are arranged along two straight lines SL1, but it is not necessary to arrange a plurality of first optical elements 31 along a straight line. It is sufficient if four first optical elements 31 defining the minimum unit 30 can be selected for each of the plurality of second optical elements 32. In order to arrange the plurality of second optical elements 32 densely, it is preferable that the first optical elements 31 are arranged at positions deviating from the straight line SL2.

In the third example embodiment, light emitters are used for the first optical elements 31 and light receivers are used for the second optical elements 32. Conversely, light receivers may alternatively be used for the first optical elements 31 and light emitters may alternatively be used for the second optical elements 32.

### Fourth Example Embodiment

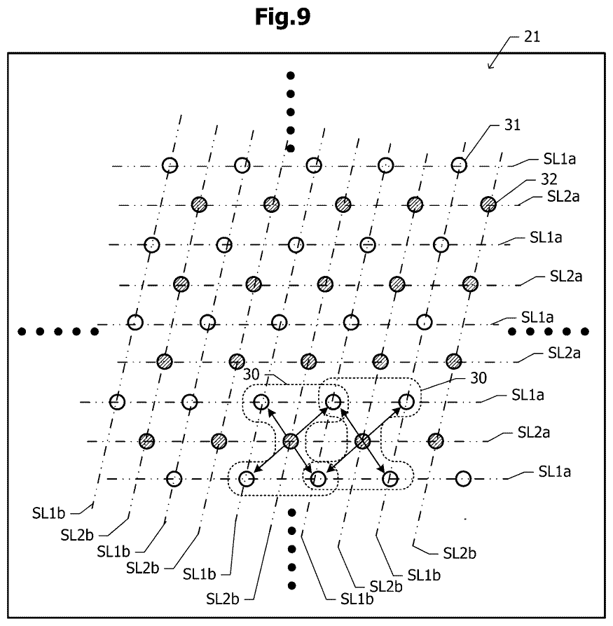

Next, an object detection sensor according to a fourth example embodiment of the present invention will be described with reference to FIG. 9. Hereinafter, the description of the configurations common to the object detection sensor according to the third example embodiment described with reference to FIG. 8A will be omitted.

FIG. 9 is a view showing the planar positional relationship of first optical elements 31 and second optical elements 32 of the object detection sensor according to the fourth example embodiment. In FIG. 9, the second optical elements 32, which are light receivers, are hatched. In the third example embodiment (FIG. 8A), the plurality of second optical elements 32 are arranged one-dimensionally along the one straight line SL2. In contrast, in the fourth example embodiment, the plurality of second optical elements 32 are arranged two-dimensionally on a virtual plane 21.

For example, the plurality of second optical elements 32 are arranged respectively at a plurality of intersections between a plurality of straight lines SL2a arranged in parallel or substantially in parallel with each other at equal or substantially equal intervals and a plurality of straight lines SL2b arranged in parallel or substantially parallel with each other at equal or substantially equal intervals, in which the plurality of straight lines SL2b intersect the plurality of straight lines SL2a. In other words, the plurality of second optical elements 32 are arranged at equal or substantially equal intervals in a first direction parallel or substantially parallel to the straight line SL2a, and arranged at equal or substantially equal intervals in a second direction parallel or substantially parallel to the straight line SL2b.

The plurality of first optical elements 31 are arranged respectively at a plurality of intersections between the plurality of straight lines SL1a arranged in parallel or substantially in parallel with the straight line SL2a at equal or substantially equal intervals and the plurality of straight lines SL1b arranged in parallel or substantially in parallel with the straight line SL2b at equal or substantially equal intervals. In other words, the plurality of first optical elements 31 are arranged at equal or substantially equal intervals in the first direction parallel or substantially parallel to the straight line SL1a, and arranged at equal or substantially equal intervals in the second direction parallel or substantially parallel to the straight line SL1b. The straight lines SL1a are each arranged at the center of two straight lines SL2a adjacent to each other, and the straight lines SL1b are each arranged at the center of two straight lines SL2b adjacent to each other.

Four first optical elements 31 defining the minimum unit 30 can be selected for each of the plurality of second optical elements 32. Further, four first optical elements 31 can be selected so that the positional relationship of the second optical element 32 and the four first optical elements 31 is the same or substantially the same between the plurality of minimum units 30.

Next, excellent effects of the fourth example embodiment will be described.

In the fourth example embodiment, the line profile of the surface of the target object 50 along each of the plurality of straight lines SL2a and the line profile of the surface of the target object 50 along each of the plurality of straight lines SL2b can be obtained. Further, in the fourth example embodiment, since no first optical element 31 is arranged between two second optical elements 32 arranged in the direction parallel or substantially parallel to the straight line SL2a and between two second optical elements 32 arranged in the direction parallel or substantially parallel to the straight line SL2b, the plurality of second optical elements 32 (measuring points) can be densely arranged two-dimensionally.

One first optical element 31 is shared by a plurality of minimum units 30. Therefore, the number of first optical elements 31 can be reduced.

Next, an object detection sensor according to a modification of the fourth example embodiment will be described.

In the fourth example embodiment, the plurality of second optical elements 32 are arranged at equal or substantially equal intervals along the straight line SL2a and arranged at equal or substantially equal intervals along the straight line SL2b. However, it is not necessary to arrange a plurality of second optical elements 32 along a straight line. It is sufficient if each of the plurality of second optical elements 32 is arranged two-dimensionally, and four first optical elements 31 defining the minimum unit 30 are arranged for the respective second optical elements 32. At this time, one first optical element 31 may be arranged so as to be shared by a plurality of minimum units 30.

### Fifth Example Embodiment

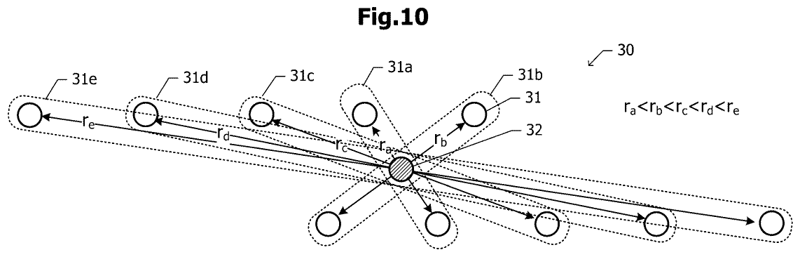

Next, an object detection sensor according to a fifth example embodiment of the present invention will be described with reference to FIGS. 10, 11, and 12. Hereinafter, the description of the configurations common to the object detection sensor according to the fourth example embodiment described with reference to FIG. 9 will be omitted.

FIG. 10 is a schematic plan view showing the positional relationship of a plurality of first optical elements 31 included in one minimum unit 30, of a plurality of minimum units 30, and one second optical element 32 of the object detection sensor according to the fifth example embodiment. In the fourth example embodiment (FIG. 9), the minimum unit 30 includes one second optical element 32 and two first optical element pairs (four first optical elements 31). In contrast, in the fifth example embodiment, each of the minimum units 30 includes one second optical element 32 and three or more first optical element pairs (six or more first optical elements 31). FIG. 10 shows an example in which one minimum unit 30 includes five first optical element pairs 31a, 31b, 31c, 31d, and 31e. In the object detection sensor according to the fourth example embodiment (FIG. 9), ten first optical elements 31 can be selected for each of the plurality of second optical elements 32 so that one minimum unit 30 includes five first optical element pairs.

The distances from respective first optical elements 31 of the first optical element pairs 31a, 31b, 31c, 31d, and 31e to the second optical element 32 are denoted by rₐ, r_{b}, r_{c}, r_{d}, and rₑ, respectively. The magnitude relationship of the distances rₐ, r_{b}, r_{c}, r_{d}, and rₑ is as follows.

rₐ<r_{b}<r_{c}<r_{d}<rₑ . . . (13)

As an example, rₐ=about 5 mm, r_{b}=about 7.5 mm, r_{c}=about 10 mm, r_{d}=about 15 mm, and rₑ=about 20 mm.

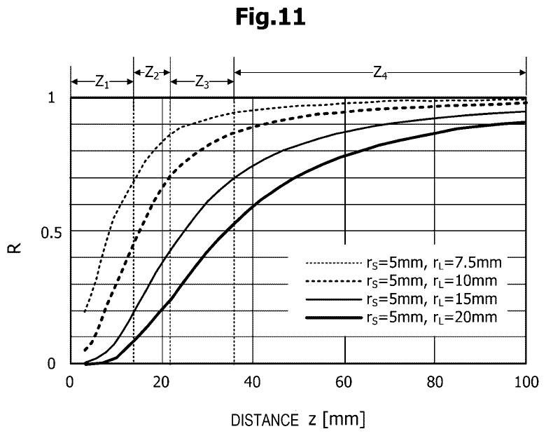

FIG. 11 is a graph showing the relationship between the ratio R (Equation (8)) when two first optical element pairs and one second optical element 32 are operated and the distance z. The horizontal axis represents the distance z in units [mm], and the vertical axis represents the ratio R. The distances from the first optical elements 31 of the two first optical element pairs to be operated to the second optical element 32 are denoted by rₛ and r_{L}. Here, rₛ<r_{L}. In the graph shown in FIG. 11, the thin dashed line, the thick dashed line, the thin solid line, and the thick solid line respectively indicate the ratios R when r_{L}=about 7.5 mm, r_{L}=about 10 mm, r_{L}=about 15 mm, and r_{L}=about 20 mm. Note that, in all cases, rₛ=about 5 mm.

It can be seen that the ratio R increases as the distance z increases. Also, the shorter the distance r_{L}, the faster the ratio R increases. In order to improve the measurement accuracy of the distance z, it is preferable to calculate the distance z using a region where the slope of the graph is large. In other words, as the distance z increases, it is preferable to operate the first optical element pair having a long distance r_{L} to use the ratio R. In the example shown in FIG. 11, when the distance z is within the ranges of the divisions Z₁, Z₂, Z₃, and Z₄, respectively, it is preferable to operate the first optical element pairs having distances r_{L} of about 7.5 mm, about 10 mm, about 15 mm, and about 20 mm, respectively. Note that, in any case, the first optical element pairs having a distance rₛ of about 5 mm are operated.

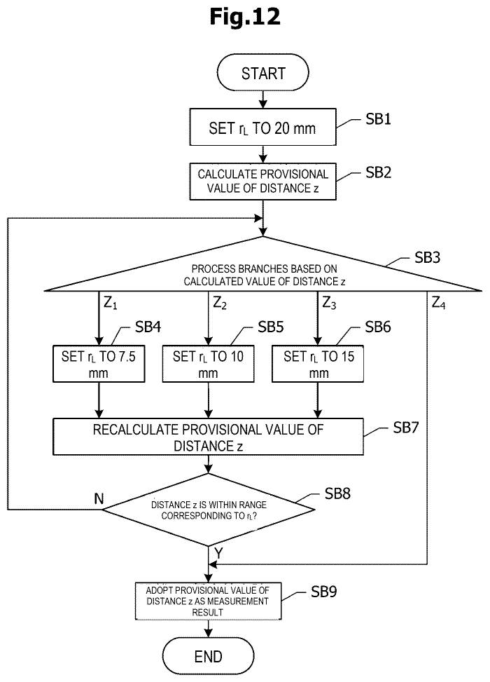

FIG. 12 is a flowchart showing a procedure to be executed by the calculator 40 (FIG. 1A) of the object detection sensor according to the fifth example embodiment. First, the calculator 40 sets the distance r_{L} to about 20 mm (step SB1). In other words, a first optical element pair 31a having a distance rₛ of about 5 mm and a first optical element pair 31e having a distance r_{L} of about 20 mm are operated. Each of the two first optical element pairs 31a and 31e is operated to measure the luminances La₁, La₂, Lb₁, and Lb₂ in Equation (8). The luminances La₁ and La₂ are measured by operating the two first optical elements 31 of the first optical element pair 31a having a distance rₛ of about 5 mm. The luminances Lb₁ and Lb₂ are measured by operating the two first optical elements 31 of the first optical element pair 31e having a distance r_{L} of about 20 mm. Based on the measurement result, a provisional value of the distance z is calculated using Equation (8) (step SB2).

Next, processing corresponding to the provisional value of the distance z is executed (step SB3). When the provisional value of the distance z is within the range of division Z₁ shown in FIG. 11, r_{L} is set to about 7.5 mm (step SB4). When the provisional value of the distance z is within the range of division Z₂ shown in FIG. 11, r_{L} is set to about 10 mm (step SB5). When the provisional value of the distance z is within the range of division Z₃ shown in FIG. 11, r_{L} is set to about 15 mm (step SB6). When the provisional value of the distance z is within the range of division Z₄ shown in FIG. 11, the provisional value of the distance z is adopted as the measurement result (step SB8).

After the distance ri is reset in steps SB4, SB5, or SB6, the first optical element pair corresponding to the set distance r_{L} is operated to recalculate the provisional value of the distance z (step SB7). Also at this time, the distance rₛ remains about 5 mm.

It is determined whether or not the recalculated provisional value of the distance z is within the range corresponding to the set value of the distance r_{L} in the divisions Z₁, Z₂, Z₃, and Z₄ shown in FIG. 11 (step SB8). If the recalculated provisional value of the distance z is not within the range corresponding to the set value of the distance r_{L}, the procedure from step SB3 is repeated. If the recalculated provisional value of the distance z is within the range corresponding to the set value of the distance r_{L}, the recalculated provisional value of the distance z is adopted as the measurement result (step SB9).

Thus, in the fifth example embodiment, first, the first

optical elements 31 of the two first optical element pairs selected from the plurality of first optical element pairs and the second optical element 32 are operated to obtain the provisional value of the distance z (step SB2). Based on the obtained provisional value, two first optical element pairs are selected from the plurality of first optical element pairs (Steps SB4, SB5, SB6), and the first optical element 31 of the selected two first optical element pairs and the second optical element 32 are operated to recalculate the provisional value of the distance z (step SB7). In such a manner, two preferred first optical element pairs are operated according to the provisional value of the distance z to obtain the distance z.

Next, excellent effects of the fifth example embodiment will be described.

In the fifth example embodiment, measurement is performed by operating the first optical element pairs optimum for the value of the distance z for each of the plurality of minimum units 30 (FIGS. 9 and 10). Therefore, measurement accuracy of the distance z can be increased.

Next, an object detection sensor according to a modification of the fifth example embodiment will be described.

In the fifth example embodiment, each of the minimum units 30 includes five first optical element pairs 31a, 31b, 31c, 31d, and 31e, but the number of first optical element pairs included in the minimum unit 30 is not limited to five as long as the number is three or more. When each of the minimum units 30 includes three first optical element pairs, two divisions are provided in FIG. 11. In such a case, in step SB3 (FIG. 12), the process branches into two divisions. If the provisional value of the distance z is within the range of the preferable division, the provisional value is used as the measurement result (corresponding to step SB9). If the provisional value of the distance z is outside the range of the preferable division, the first optical element pair with different distances r_{L} is selected and the provisional value of the distance z is recalculated (corresponding to step SB7).

In the fifth example embodiment, in step SB1 (FIG. 12), the distance r_{L} is set to the longest value of about 20 mm. This is because it is assumed that the target object 50 (FIG. 1A) is often detected at a position far from the object detection sensor and then approaches the object detection sensor. However, if the range of the distance z in which the target object 50 is assumed to be detected first is assumed in advance, the distance r_{L} may be set to a value corresponding to the assumed distance z in step SB1 (FIG. 12).

Each of the example embodiments described above is exemplary, and partial substitution or combination of the configurations shown in the different example embodiments is possible. The same or similar advantageous effects of the same or similar configurations of the example embodiments are not described sequentially for each example embodiment. Further, the present invention is not limited to the example embodiments described above. For example, it should be obvious to those skilled in the art that various modifications, improvements, combinations and the like can be made.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An object detection sensor comprising:
at least four first optical elements arranged on a virtual plane;
at least one second optical element arranged on the virtual plane; and
a calculator; wherein
one of the at least four first optical elements and the at least one second optical element is a light emitter, and another of the at least four first optical elements and the at least one second optical element is a light receiver;
at least four of the first optical elements and one of the second optical element define a minimum unit;
directional characteristics of the at least four first optical elements of the minimum unit are the same or substantially the same, and directional characteristics of the at least one second optical element are such that, when a straight line extending from the at least one second optical element in a direction normal to the virtual plane is defined as a reference axis, a tilt angle at which an illumination intensity or a light receiving sensitivity in a direction tilting from the reference axis becomes about ½ of the illumination intensity or the light receiving sensitivity in a direction of the reference axis is about 15° or less;
the at least four first optical elements of the minimum unit are neither arranged on one common straight line passing through the at least one second optical element, nor on one common circumference centered on the at least one second optical element; and
the calculator is configured or programmed to obtain a distance from the virtual plane to a target object on the reference axis, an inclination angle of a direction normal to a surface of the target object with respect to the reference axis, and an inclination azimuth angle based on a measurement value, which is a light receiving intensity when each of the at least four first optical elements of the minimum unit and the at least one second optical element are operated.

2. The object detection sensor according to claim 1, wherein the minimum unit includes at least two first optical element pairs including two of the at least four first optical elements arranged in mutually point-symmetric positions with respect to the at least one second optical element.

3. The object detection sensor according to claim 2, wherein the calculator is configured or programmed to obtain the distance from the virtual plane to the target object based on a sum of the measurement values when the first optical elements of one of the first optical element pairs and the second optical element are operated and a sum of the measurement values when the first optical elements of another of the first optical element pairs and the second optical element are operated.

4. The object detection sensor according to claim 3, wherein the minimum unit includes at least three first optical element pairs;
the calculator is configured or programmed to operate the first optical elements of the two first optical element pairs selected from the three first optical element pairs and the second optical element to obtain a provisional value of the distance from the virtual plane to the target object; and
the calculator is configured or programmed to select, based on the provisional value, two of the first optical element pairs from the at least three of the first optical element pairs, and to obtain the distance from the virtual plane to the target object based on the measurement values when the first optical elements of the selected two first optical element pairs and the second optical element are operated.

5. The object detection sensor according to claim 2, wherein the calculator is configured or programmed to obtain the inclination angle of the direction normal to the surface of the target object with respect to the reference axis, and the inclination azimuth angle based on a difference between the measurement values when the first optical elements of one of the first optical element pairs and the second optical element are operated and a difference between the measurement values when the first optical elements of another of the first optical element pairs and the second optical element are operated.

6. The object detection sensor according to claim 2, wherein
a plurality of the second optical elements are provided;
a plurality of the first optical elements are arranged so as to define the minimum unit for each of the plurality of the second optical elements; and
at least one of the plurality of the first optical elements is shared by at least two of the minimum units.

7. The object detection sensor according to claim 6, wherein the plurality of the second optical elements are arranged on one straight line.

8. The object detection sensor according to claim 6, wherein
the plurality of the second optical elements are arranged at equal or substantially equal intervals in a first direction and arranged at equal or substantially equal intervals in a second direction intersecting the first direction;
the plurality of the first optical elements are arranged at equal or substantially equal intervals in the first direction and arranged at equal or substantially equal intervals in the second direction;
the arrangement interval of the plurality of first optical elements in the first direction is equal or substantially equal to the arrangement interval of the plurality of second optical elements in the first direction; and
the arrangement interval of the plurality of first optical elements in the second direction is equal or substantially equal to the arrangement interval of the plurality of second optical elements in the second direction.

9. The object detection sensor according to claim 1, wherein each of the first optical elements includes a light emitting diode or a vertical cavity surface emitting laser.

10. The object detection sensor according to claim 1, wherein the second optical element includes a photodiode, a phototransistor, or a CdS cell.

11. The object detection sensor according to claim 1, wherein the directional characteristics of the second optical element is about 15° or less.

12. The object detection sensor according to claim 1, wherein the directional characteristics of the second optical element is about 10° or less.

13. The object detection sensor according to claim 1, wherein the directional characteristics of the second optical element is about 5° or less.

14. The object detection sensor according to claim 1, wherein the calculator is configured or programmed to sequentially emit light from the at least four first optical elements.

15. An object detection method of operating, of a minimum unit including each of at least four first optical elements and at least one second optical element arranged on a common virtual plane, the at least four first optical elements and the at least one second optical element, and detecting a target object on a reference axis extending from the at least one second optical element in a direction normal to the virtual plane, wherein one of the at least four first optical elements and the at least one second optical element is a light emitter, and another of the at least four first optical elements and the at least one second optical element is a light receiver, directional characteristics of the at least four first optical elements of the minimum unit are the same or substantially the same, and directional characteristics of the at least one second optical element are such that a tilt angle at which an illumination intensity or a light receiving sensitivity in a direction tilting from the reference axis becomes about ½ of the illumination intensity or the light receiving sensitivity in a direction of the reference axis is about 15° or less; and the at least four first optical elements of the minimum unit are neither arranged on one common straight line passing through the at least one second optical element, nor on one common circumference centered on the at least one second optical element, the object detection method comprising:
obtaining a measurement value of luminance when the target object is used as a new light source based on light emitted from either the at least four first optical elements or the at least one second optical element of the minimum unit, reflected by the target object, and received by another of the at least four first optical elements and the at least one second optical element of the minimum unit; and
calculating, based on the measurement value, at least one of a reflectivity of a surface of the target object, a distance from the virtual plane to the target object on the reference axis, an inclination angle of the surface of the target object with respect to the reference axis, or an inclination azimuth angle of the surface of the target object.

16. The object detection method according to claim 15, wherein the minimum unit includes at least two first optical element pairs, each of the first optical element pairs including two of the first optical elements arranged in mutually point- symmetric positions with respect to the second optical element, the object detection method further comprising:
calculating a sum of the measurement values measured by operating the first optical elements of one of the first optical element pairs and the second optical element, and a sum of the measurement values measured by operating the first optical elements of another of the first optical element pairs and the second optical element; and
calculating, based on the sum of the measurement values, a distance from the virtual plane to the target object on the reference axis.

17. The object detection method according to claim 16, further comprising:
calculating a difference between the measurement values measured by operating the first optical elements of the one of the first optical element pairs and the second optical element, and a difference between the measurement values measured by operating the first optical elements of the other of the first optical element pairs and the second optical element; and
calculating, based on the difference between the measurement values, at least one of an inclination angle of the surface of the target object with respect to the reference axis and an inclination azimuth angle of the surface of the target object.

18. The object detection method according to claim 16, wherein the minimum unit includes at least three first optical element pairs, the object detection method further comprising: operating the first optical elements of two of the first optical element pairs selected from the at least three of the first optical element pairs and the second optical element to obtain a provisional value of a distance from the virtual plane to the target object, selecting, based on the provisional value, two of the first optical element pairs from the at least three of the first optical element pairs, and operating the first optical elements of the selected two of the first optical element pairs and the second optical element to obtain the distance from the virtual plane to the target object.
